(19) United States
(12) Patent Application Publication
(10) Pub. No.: US 2017/0164722 A1
(43) Pub. Date: Jun. 15, 2017

(54) CONNECTOR FOR RETAINING MULTIPLE PLANT POTS IN AN UPRIGHT ORIENTATION

(71) Applicant: AFTEX INDUSTRIES, Franklin Square, NY (US)

(72) Inventors: STEVEN KUNREUTHER, New York, NY (US); ANDREW FRANZONE, JR., West Islip, NY (US)

(21) Appl. No.: 15/377,100

(22) Filed: Dec. 13, 2016

Related U.S. Application Data
(60) Provisional application No. 62/267,326, filed on Dec. 15, 2015.

(51) Int. Cl. A45F 5/10; B65D 25/22; A01G 9/02

(52) U.S. Cl. CPC A45F 5/102; A01G 9/027; B65D 25/22

(57) ABSTRACT

The connector attaches pots to form an assembly. The connector includes a rigid part adapted to extend into the interior of a pot, a rigid exterior part adapted to extend between the pots and a moveable member, attached to the exterior part, having an unattached end spaced from the interior part. As the connector is mounted on a pot, the interior part is inserted into the pot interior and the upper portion of the pot pushes the unattached end of the moveable member away from the interior part. After the rim of the pot clears the unattached end of the moveable member, the end returns to its original position and lodges under the rim to secure the pot to the connector. A pot separating member extends downwardly between the pots and has one or more sets of outwardly extending arms which retain the pots in their upright orientation as the assembly is transported.

### CROSS-REFERENCE TO RELATED APPLICATIONS

Priority is claimed on Provisional Patent Application No. 62/267,326, filed Dec. 15, 2015, the entire contents of which are incorporated herein by reference.

### STATEMENT REGARDING FEDERALLY SPONSORED RESEARCH OR DEVELOPMENT

Not Applicable

### REFERENCE TO A “SEQUENCE LISTING”, A TABLE, OR A COMPUTER PROGRAM LISTING APPENDIX SUBMITTED ON COMPACT DISC

Not Applicable

### BACKGROUND OF THE INVENTION

1. Field of the Invention

The present invention relates to pots in which various types of plants are transported, displayed and sold, and more particularly to a device for use in connecting multiple plant pots with a wide variety of different rim configurations to form an assembly in which the pots remain in an upright orientation as the assembly is transported.

2. Description of Prior Art Including Information Disclosed Under 37 Cfr 1.97 and 1.98

Plants of various types are grown, transported and displayed for sale in pots of various sizes and shapes. The pots are commonly made of plastic and have rims which surround the wall of the pot and protrude outwardly from the upper portion of the pot wall. The thickness of the pot walls vary, as does the shape and size of the rims of the pots.

For ease of handling and for marketing purposes it is advantageous to connect the pots together to form an assembly, particularly pots which contain plants which have a common characteristic, such as being of the same species, color, size, or having similar light or watering requirements. In order to connect the pots together, we developed the connector disclosed in our U.S. Pat. No. 9,149,934.

In our patented connector, all of the parts which engage the rim of the pot are rigid. For that reason, it is necessary that the rim of the pot be somewhat flexible such that the rim can bend inward toward the pot wall as the connector is applied and then return to its original position after the connector is in place. Otherwise, the connector cannot be mounted on the pot.

As a result, the patented connector can only be used with pots which have certain characteristics. If the rim of the pot is too thick or too thin, or too rigid, the connector cannot be applied to the pot. One aspect of the present invention relates to an improved pot engaging structure which is simpler than that of the patented connector and can accommodate pots of various thicknesses, and those having a large variety of different size and shaped rims.

The patented connector also did not adequately address what occurs when a multiple pot assembly is lifted in the air. When three pots are connected in a linear arrangement and the assembly is lifted, gravity causes the bottoms of the pots to move inward toward each other until they touch. The smaller the circumference of the pot is at the bottom relative to the top, the larger is this movement.

Because of that inward movement, after the assembly of pots is lifted in the air, in many cases it is virtually impossible to set the pots back down on a flat surface without manually moving the bottom portions of the pots away from each other. Another aspect of the present invention addresses this problem by providing a separator extension which retains the pots in the assembly in an upright orientation during transport.

### BRIEF SUMMARY OF THE INVENTION

The connector of the present invention has a pot engaging structure which can accommodate pots of various thicknesses with a large variety of different size and shape rims. The engaging structure consists of a rigid part designed to extend into the pot interior and a moveable member with an unattached end, spaced from the rigid interior part, situated adjacent the exterior surface of the pot. As the connector is attached to the pot, the rigid part is inserted into the interior of the pot and the top of the pot pushes the unattached end of the moveable member away from the exterior surface of the pot wall. After the rim of the pot clears the unattached end of the moveable member, the unattached end of the moveable member returns to its original position with the unattached end of the moveable member now lodged under the rim of the pot. This structure allows the connector to be used with pots of a various thicknesses having a great many different rims shapes and sizes and at the same time insures that the pot will be securely attached to the connector.

The connector of the present invention retains each of the engaged pots in the upright orientation through the use of a pot separating member which extends downwardly between the pots of the assembly from the pot engaging portion. The separating member has outwardly extending arms which abut the exterior walls of the pots. The arms prevent the pots from moving toward each other when the assembly is lifted. The separating member retains the pots in their upright orientation at all times, allowing the assembly to be placed on a flat surface.

In accordance with the present invention, a device is provided for connecting plant pots to form an assembly. The pots are of the type having a wall with an upper portion, an interior, an exterior, and an outwardly protruding rim.

The device includes means for engaging each pot. The engaging means includes a rigid member having a part adapted to extend into the pot interior and a part adapted to extend along the pot exterior. The interior part and the exterior part are spaced from each other such that the upper portion of the pot wall may be received therebetween.

A moveable member is provided having an end which is pivotally attached to the exterior part. The moveable member has an unattached end. The moveable member is biased toward the interior part such that as the upper portion of the pot pushes the unattached end of the moveable member out of its path as it is received between the interior part and the exterior part, the unattached end of the moveable member lodges under the rim to secure the pot as the moveable member returns to its original position.

The device further includes a stop member which limits the range of movement of the moveable member toward the interior part. The stop member includes a protrusion which extends in a plane generally parallel to the interior part. The moveable member has a recess adapted to receive the stop member.

The connector is designed for use with a handle. Means are provided for attaching the handle to the pot engaging structure.

The connector preferably has two pot engaging structures. The two pot engaging structures share a common exterior part such that two pots can be connected in side-by-side relation.

The common exterior part includes a downwardly extending pot separating member. The pot separating member carries outwardly extending arms directed towards the exterior wall of each pot. The arms have unattached ends. Members adapted to abut the exterior walls of the pots are fixed to the unattached ends of the arms.

Means may be provided to pivotally attach the end of the moveable member to the surface of the exterior part. Those means may take the form of a living hinge.

In accordance with another aspect of the present invention, a device is provided for connecting plant pots to form an assembly. The pots are of the type having a wall with an exterior. The device includes means for engaging the pots in side-by-side relation. The pot engaging means includes a member extending between the pots. The extending member includes means for maintaining each of the connected pots in a substantially upright orientation. The maintaining means includes first and second arms each of which extends towards and is adapted to abut the exterior of the wall of a different one of the connected pots.

The arms extend in substantially opposite direction from the member. Abutting members are attached to the ends of the arms. The members include surfaces adapted to abut the exterior wall of the adjacent pot.

The abutting members extend in a direction substantially perpendicular to the axis of the pots. Preferably, the surfaces of the abutting members are shaped to accommodate the curvature of the pot wall.

In accordance with another aspect of the present invention, one or more additional sets of arms may be provided. Each of arms in each set extends towards and is adapted to abut the wall of a different one of the pots in the assembly to retain the pots in their upright orientation. This embodiment is particularly useful for pots of greater than normal height.

In accordance with another aspect of the present invention, a device is provided for connecting plant pots of the type having a wall. The device includes means for engaging the pots in side-by-side relation to form an assembly. The engaging means includes a bifurcated pot separating member extending between the pots. The bifurcated member includes first and second flexible branches each of which is adapted to abut the wall of a different one of the pots in the assembly to permit limited variation in the distance between the pots.

### BRIEF DESCRIPTION OF THE SEVERAL VIEWS OF DRAWINGS

To these and to such other objects that may hereinafter appear, the present invention relates to a connector for retaining multiple plant pots in an upright orientation as described in detail in the following specification and recited in the annexed claims, taken together with the accompanying drawings, in which like numerals refer to like parts and in which:

FIG. 1 is a perspective view showing the top, front and one side of the first preferred embodiment of the connector of the present invention;

FIG. 2 is a perspective view showing the bottom, rear and other side of the connector of FIG. 1;

FIG. 3 is a perspective view of a plant pot with the connector of FIG. 1 mounted on a pot and with a handle attached to the connector;

FIG. 4 is a perspective view of an assembly including two plant pots with the connector of FIG. 1 on mounted on the pots and with a handle attached to the connector;

FIG. 5 is a perspective view of an assembly including three plant pots with two connectors of FIG. 1 mounted on the pots and with a handle attached to both connectors;

FIG. 6 is a perspective view of an assembly including three plant pots with two connectors of FIG. 1 mounted on the pots and with a separate handle attached to each connector;

FIG. 7 is an elevation view of an assembly of FIG. 5 as it would appear with the assembly resting on a horizontal surface;

FIG. 8 is an elevation view of an assembly of FIG. 5 as it would appear with the assembly lifted above the horizontal surface;

FIG. 9 is an elevation view of an assembly of three plant pots with two connectors without the pot separating member of the present invention mounted on the pots and with a handle attached to both connectors, as it would appear with the assembly lifted above the horizontal surface;

FIG. 10 is an elevation view of an assembly of FIG. 9 as it would appear as the assembly is being set down on the horizontal surface;

FIG. 11 is a perspective view of a second preferred embodiment of the connector of the present invention; and

FIG. 12 is a perspective view of a third preferred embodiment of the connector of the present invention.

### DETAILED DESCRIPTION OF THE INVENTION

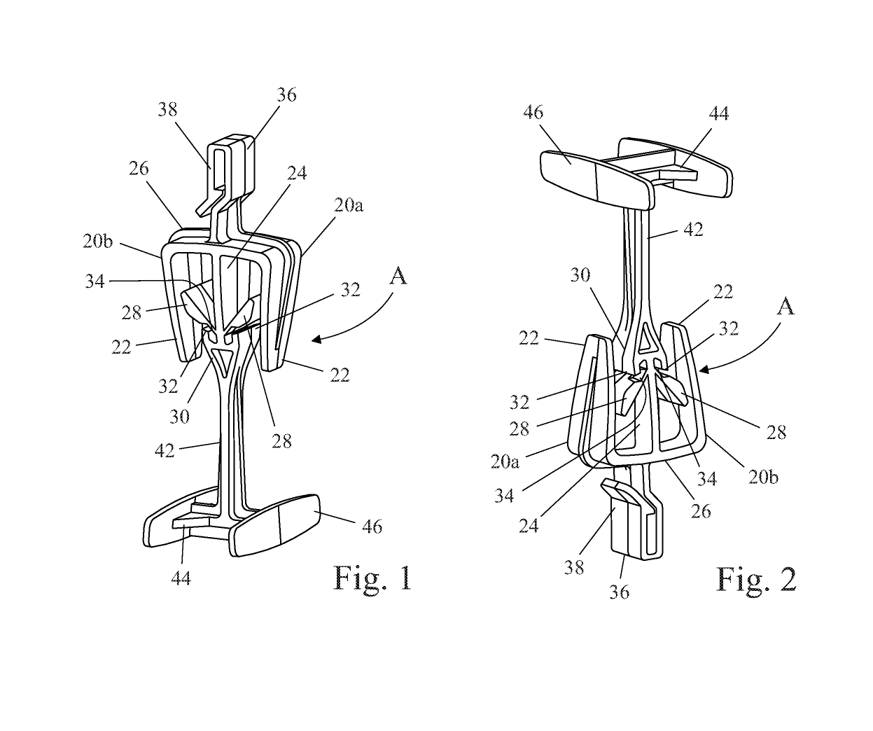

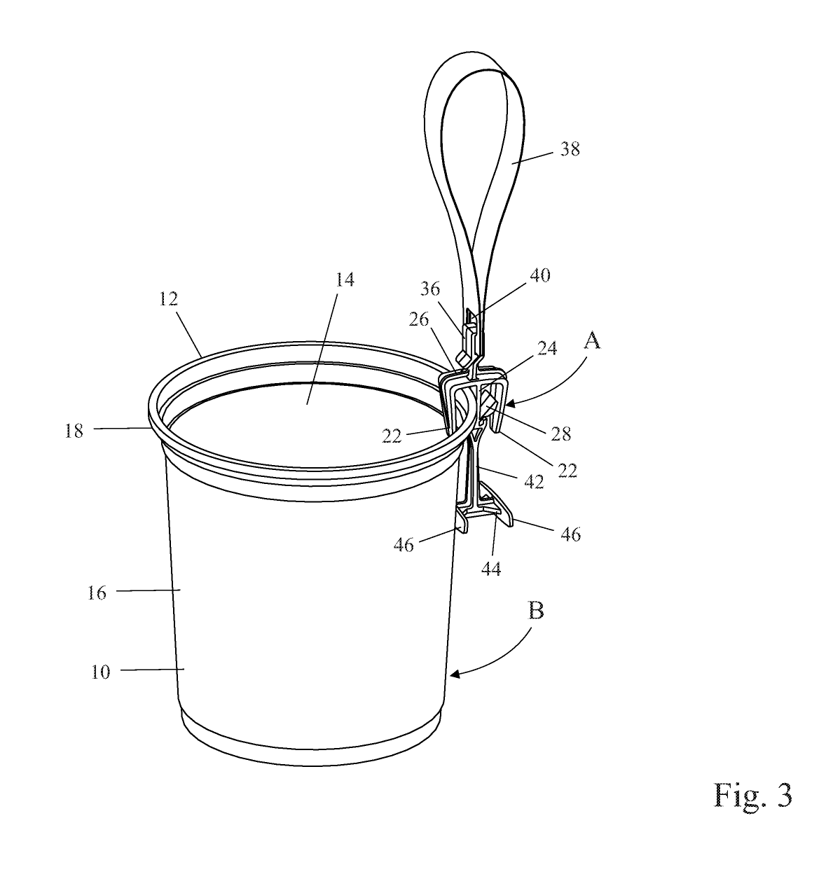

FIGS. 1 and 2 illustrate a first preferred embodiment of the connector of the present invention, generally designated A. As seen in FIGS. 3-8, connector A is a device for connecting plant pots, generally designated B, to form an assembly such that the pots can be transported and displayed as a unit.

Each of the pots B has a wall 10 with an upper portion 12, an interior 14, and an exterior 16. A rim 18 protrudes outwardly from the exterior surface 16 of wall 10.

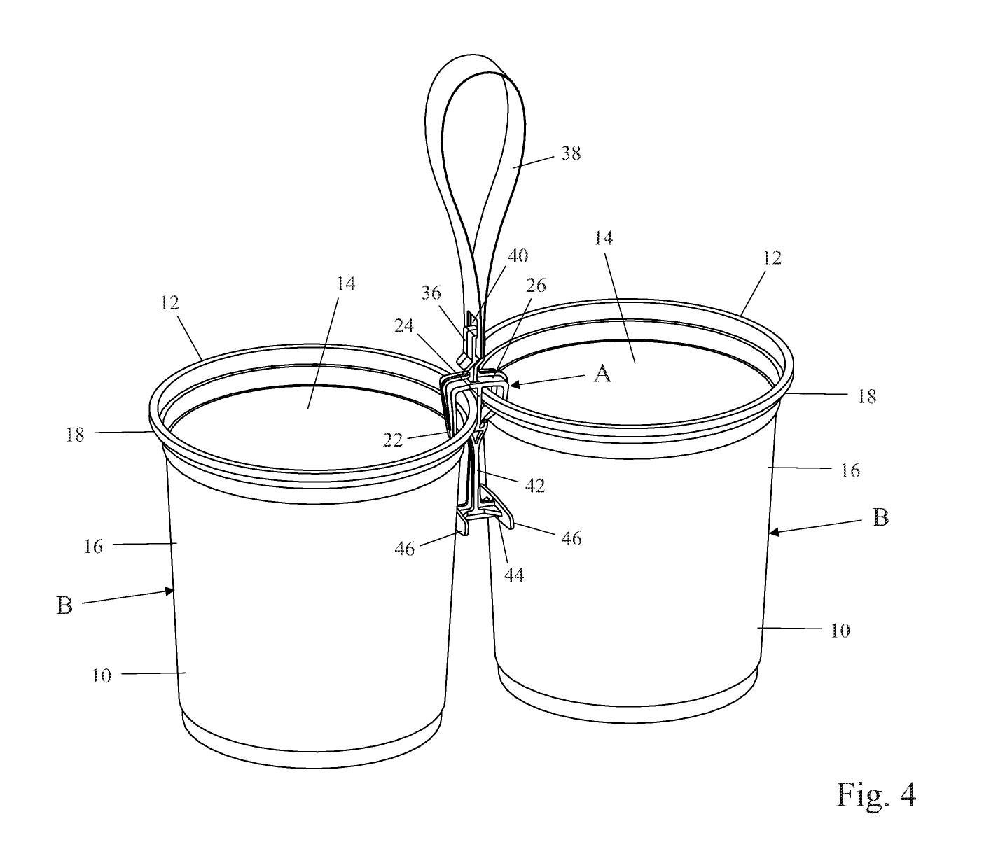

Connector A includes a pot engaging portion 20 with two branches 20a and 20b. Each branch 20a, 20b includes structure for receiving and engaging the upper portion 12 of wall 10 of a different one of the two pots B which can form a two pot assembly, such as illustrated in FIG. 4.

Each branch of the pot engaging portion 20a, 20b includes a rigid part 22 adapted to extend into the pot interior and a rigid part 24 adapted to extend along the pot exterior. Interior member 22 and exterior member 24 extend downwardly from a common rigid part 26 such that the interior member 22 and exterior member 24 are substantially parallel to and spaced from each other. Members 22, 24 and 26 of each branch of the pot engaging portion define a channel with an open bottom adapted to receive the upper portion 12 of a pot B, as illustrated in FIG. 3.

A moveable member 28 is situated in each of the channels formed in each branch of the pot engaging portion 20a, 20b. As it is used in this specification, the term “moveable member” is intended to include a rigid member, one end of which is pivotally attached to the surface of exterior part 24, preferably by a living hinge or the like and a flexible member, one end of which is fixed on the surface of exterior member 24. In either case, the unattached end of the moveable member 28 can move though an arc within the channel in which the moveable member is situated.

Preferably, the outer surface of moveable member 28 is arcuate and the inner surface of moveable member 28 is substantially planar. The moveable member is biased toward the interior part 22.

As the upper portion 12 of the pot wall 10 is received in the channel formed by members 22, 24 and 26, the rim 18 of the pot pushes the unattached end of the moveable member 28 out of its path. As the upper portion 12 of the pot moves further into the channel, the unattached end of the moveable member 28 clears the rim 18 and moves back to its original position where it lodges under the rim 18 of the pot. In that position, the moveable member secures the pot to the connector.

A stop member 30 is situated immediately below the point on exterior member 24 at which the end of moveable member 28 is attached. The stop member 30 limits the range of movement of the moveable member 28 in the direction the interior member 22 such that the moveable member 28 is maintained in the proper position to receive the rim of a pot.

The stop member includes a protrusion 32. Protrusion 32 extends in a plane generally parallel to the interior member 22. Protrusion 32 has a surface which co-operates with the moveable member 28 to position the moveable member. The moveable member has a recess 34 adapted to receive the surface of protrusion 32 of stop member 30 such that the moveable member is retained in the receiving position.

A hook-like member 36 extends upwardly from member 26. Member 36 is provided to engage the end of a flexible plastic handle 38 such that the assembly can be easily transported. Member 36 includes an arm 38 adapted to extend through an opening 40 in the end of the handle.

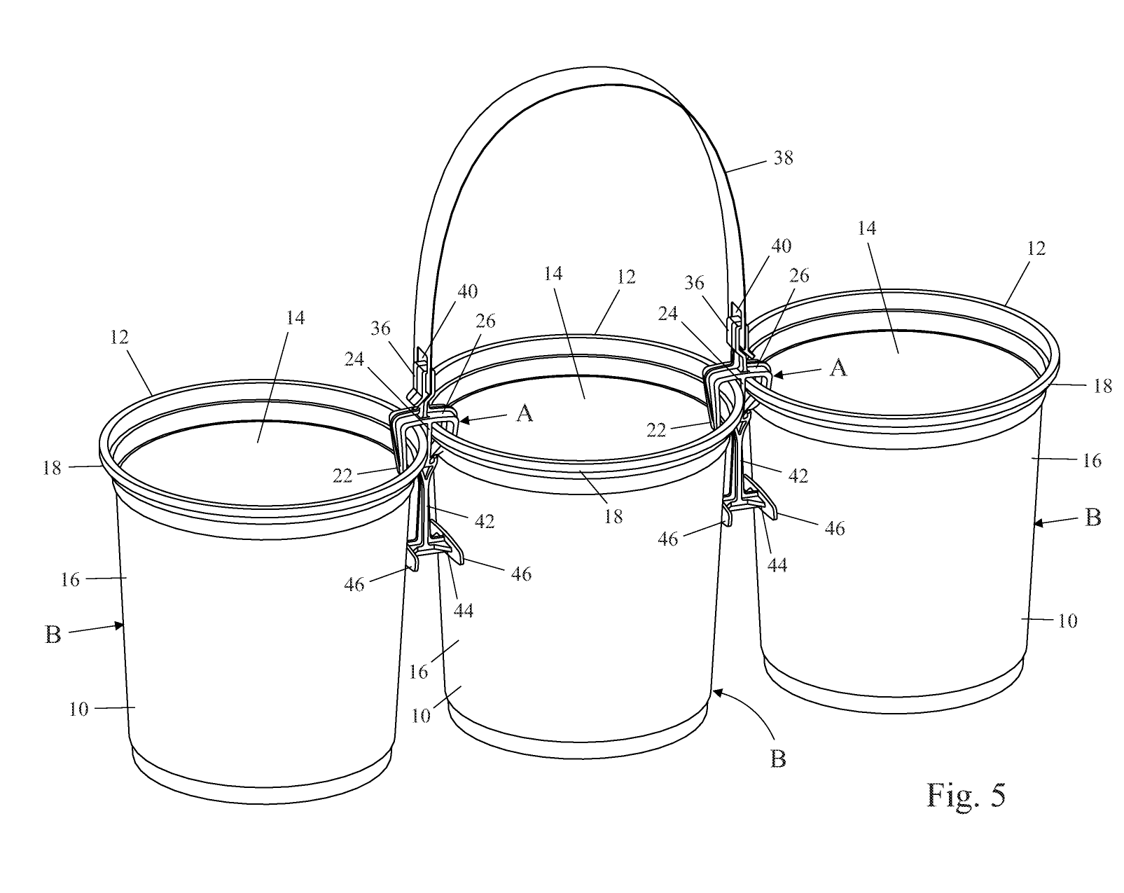

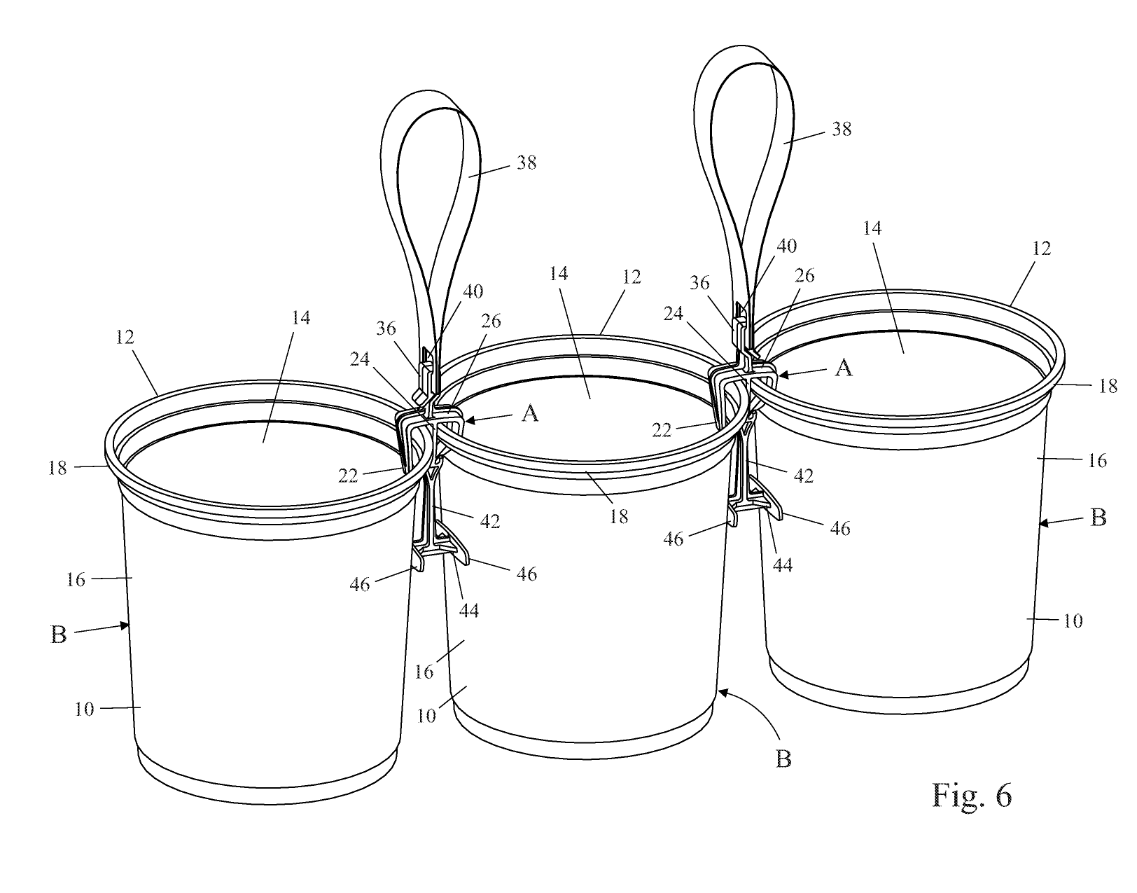

As seen in the drawings, branches 20a and 20b of connector A share a common exterior part 24. That allows the connector to connect two pots together to form an assembly, as seen in FIG. 4. Multiple connectors can be used to form assemblies with greater numbers of pots. For example, two connectors can be used to form a three pot assembly, as illustrated in FIG. 5.

The common exterior part 24 includes a downwardly extending pot separating member 42. Extending outwardly in opposite directions from the lower section of member 42 are arms 44. Each of the arms 44 extend towards a different one of the pots in the assembly. Horizontally extending abutting members 46 are attached to the ends of the arms. The exterior surfaces of the members 46 are adapted to abut the exterior walls of the pots to keep the pots upright as the assembly is lifted.

Abutting Members 46 extend in a direction substantially perpendicular to the axis of the pots. Preferably, the surfaces of members 46 are shaped to accommodate the curvature of the exterior surface of the wall of the pot. The surfaces of member 46 may be divided into sections inclined relative to each other or may be arcuate.

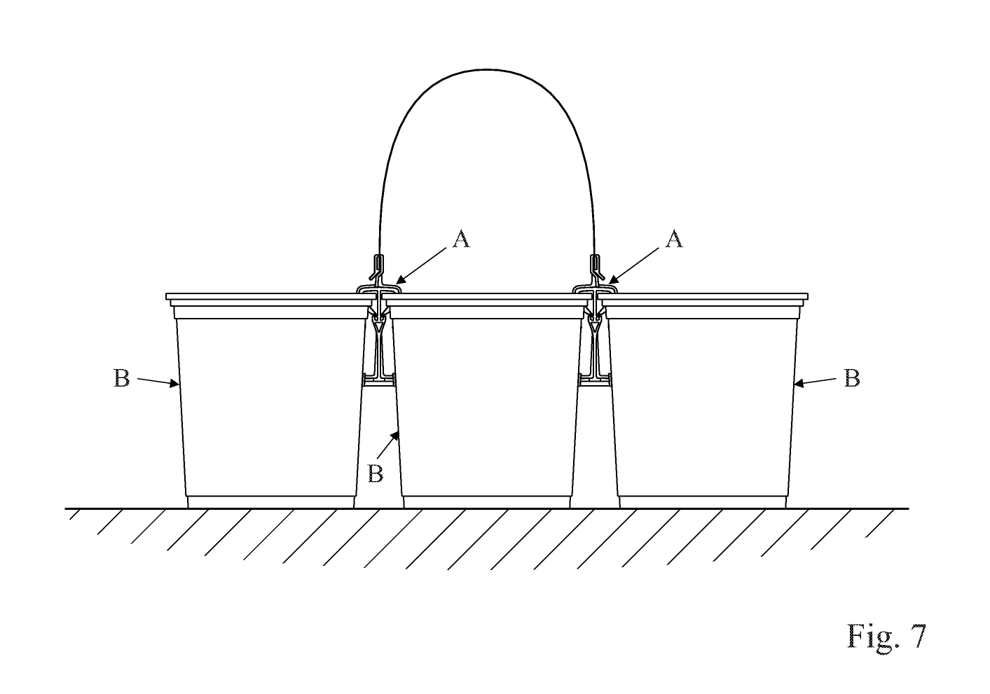

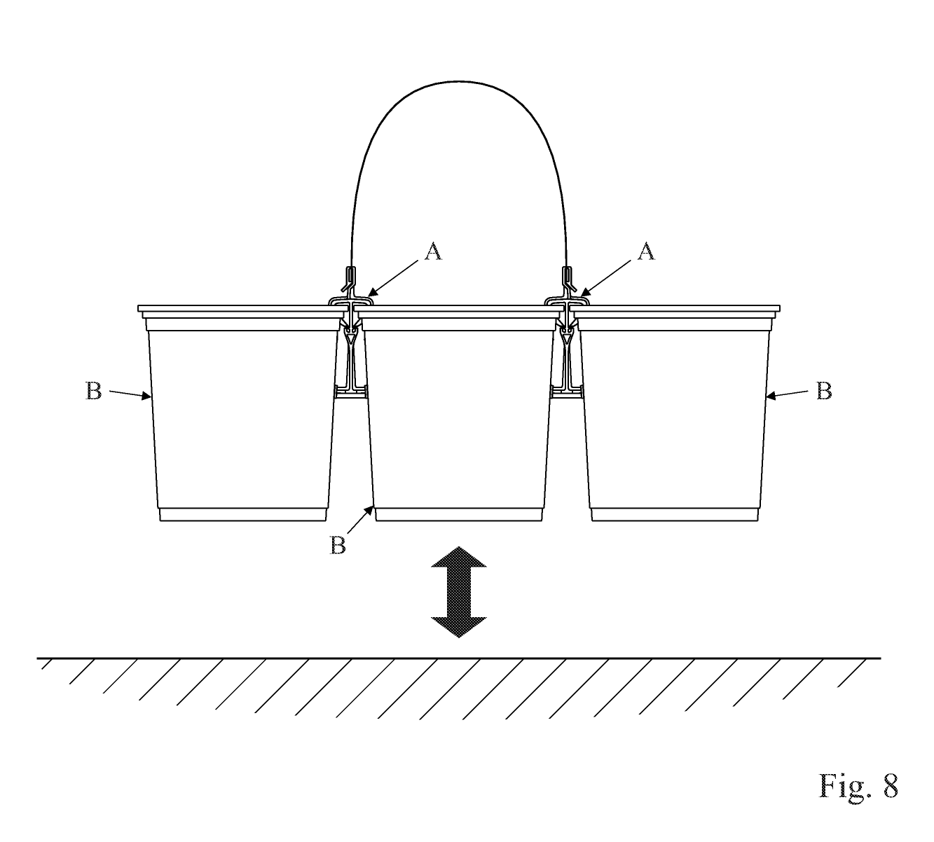

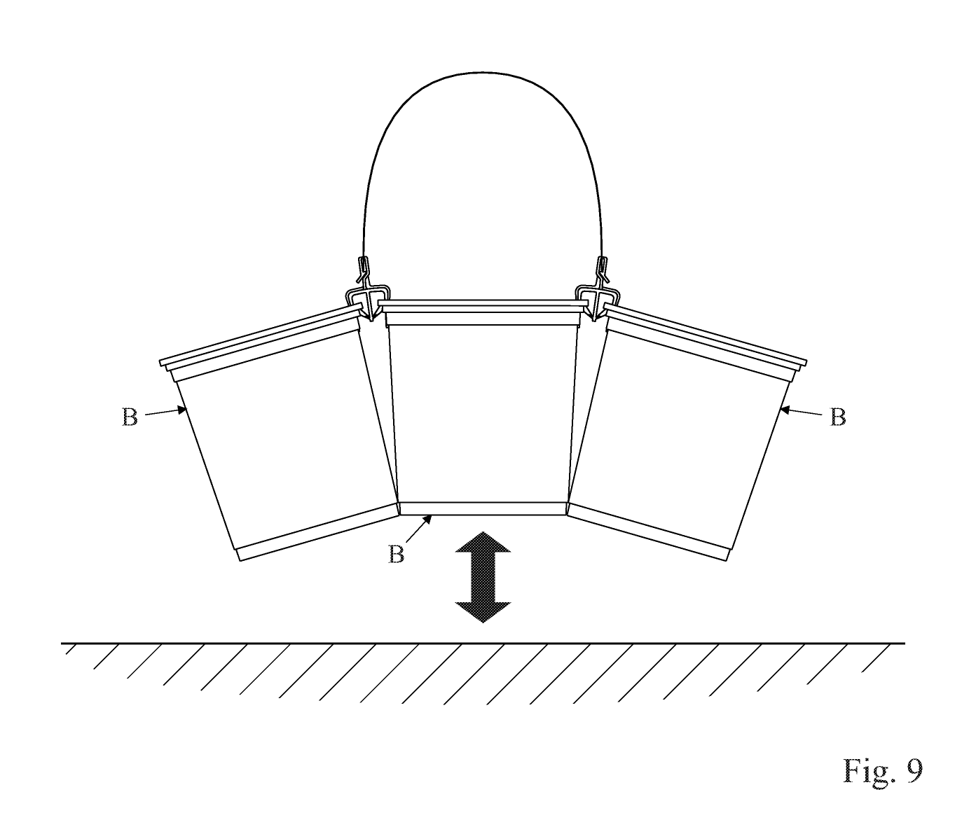

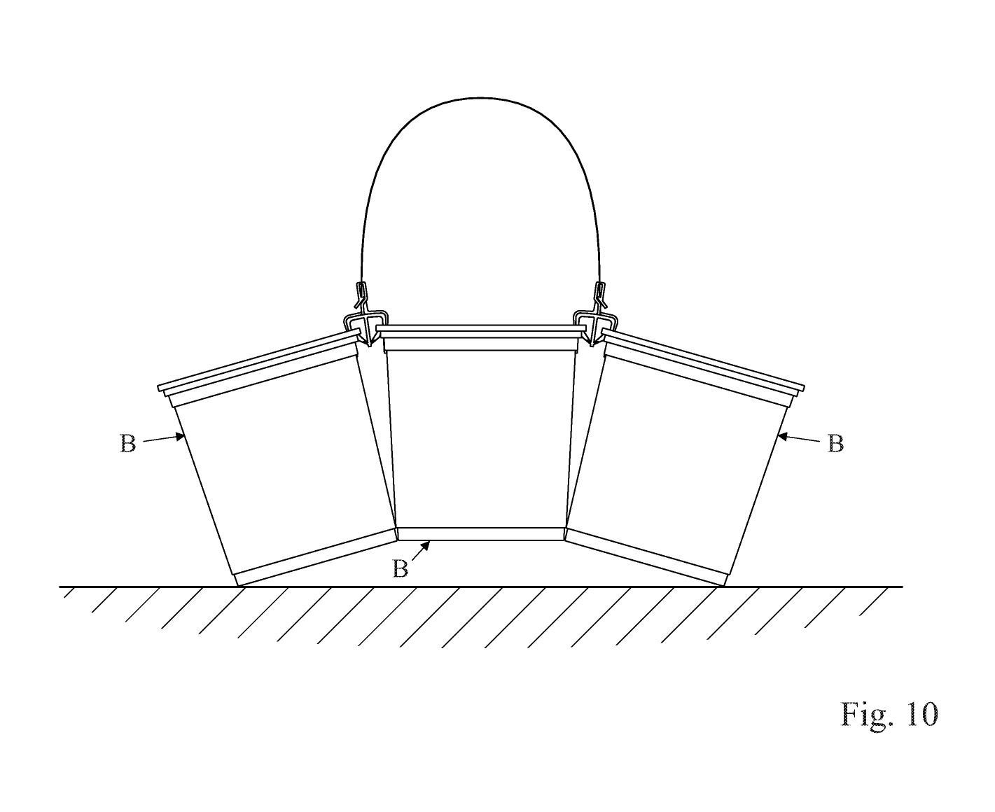

FIGS. 7 and 8 illustrate the assembly of FIG. 5 being lifted from a flat surface and how the pot separating member of the present invention retains the pots in their upright orientations as the assembly is lifted. Because the pots are retained in their upright orientations, the assembly can be placed down on a flat surface without the necessity of manually moving the bottoms of the parts away from each other. This is to be contrasted with the assembly illustrated in FIGS. 9 and 10 which is formed with connectors which do not have a pot separating member. From those figures it can be seen that the pot bottoms move together as the assembly is lifted and that the assembly cannot be placed on a flat surface without first moving the pot bottoms apart.

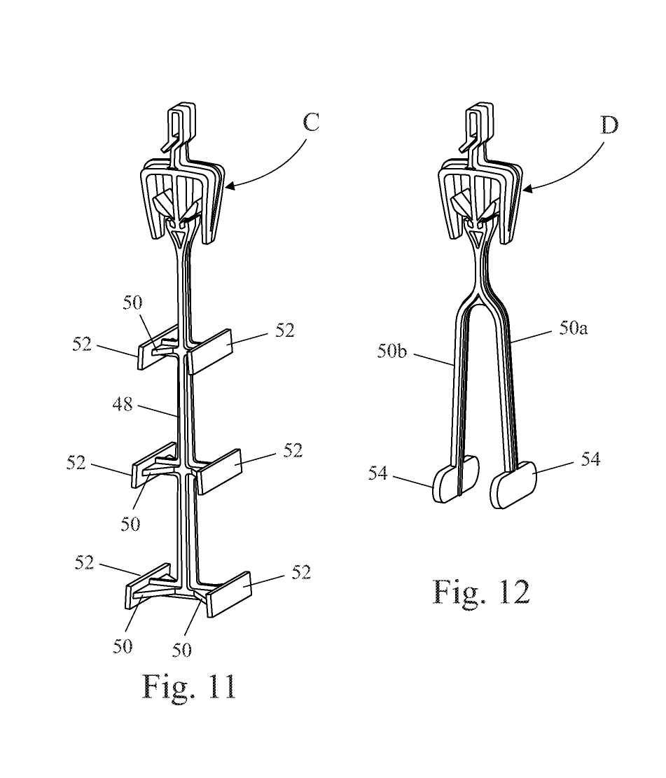

FIG. 11 illustrates a connector, generally designated C, which is second preferred embodiment of the present invention. The pot engaging portion of connector C is the same as the pot engaging portion of connector A. However, the pot separating member 42 of connector A is elongated to form an extended separating member 48 in connector C which includes multiple sets of outwardly extending arms 50 with abutting members 52. Connector C is particularly useful for taller pots.

FIG. 12 illustrates a connector, generally designated D, which is a third preferred embodiment of the present invention. In this embodiment, the separating member 42 of connector A is bifurcated to form into two flexible branches 50a and 50b. Each branch 50a, 50b has an abutting member 54 attached to its free end Like abutting members 46 of connector A, the abutting members of connector D extend in a direction substantially perpendicular to the center line of the pots and are adapted to engage the walls of the pots of the assembly to retain the pots in the assembly in their upright orientations.

However, in this embodiment, because the connector is formed of plastic which has a certain amount of flexibility, the branches 50a, 50b of the pot separating member function like a spring to permit limited variation in the distance between the pots in the assembly.

While only a limited number of preferred embodiments of the present invention have been disclosed for purposes of illustration, it is obvious that many modifications and variations could be made thereto. It is intended to cover all of those modifications and variations which fall within the scope of the present invention, as defined by the following claims:

We claim:

1. A device for connecting plant pots of the type having a wall with an upper portion, an interior, an exterior, and an outwardly protruding rim, the device comprising means for engaging each pot, said engaging means comprising a rigid member having a part adapted to extend into the pot interior and a part adapted to extend along the pot exterior, said interior part and said exterior part being spaced from each other such that the upper portion of the pot wall may be received therebetween, and a moveable member having an end attached to said exterior part and an unattached end, said unattached end of said moveable member being biased toward said interior part, such that the upper portion of the pot pushes said unattached end of said moveable member out of its path, as the upper portion of the pot is received between said interior member and said exterior member, and the unattached end of said moveable member lodges under said rim to secure the pot to the connector.

2. The device of claim 1 wherein said device comprises two engaging means.

3. The device of claim 2 wherein said two engaging means share a common exterior part.

4. The device of claim 1 further comprising a stop member limiting the range of movement of said moveable member toward said interior part.

5. The device of claim 4 wherein said stop member comprises a protrusion extending in a plane generally parallel to said interior part.

6. The device of claim 5 wherein said moveable member comprises a recess adapted to receive said stop member protrusion.

7. The device of claim 1 for use with a handle and further comprising means for attaching the handle to said rigid member.

8. The device of claim 3 wherein said common exterior member extends downwardly between the pots and further comprises arms extending outwardly towards each of the pots.

9. The device of claim 8 wherein said arms have unattached ends and further comprising members adapted to abut the pots fixed to said unattached ends of said arms.

10. The device of claim 1 further comprising means for pivotally attaching the end of said moveable member to said exterior surface of said exterior member.

11. The device of claim 10 wherein said means for pivotally attaching the end of said moveable member comprises a living hinge.

12. A device for connecting plant pots of the type having a wall, said device comprising means for engaging the pots in side-by-side relation to form an assembly, said engaging means comprising a pot separating member extending between the pots, said member comprising first and second arms each of which extends towards and is adapted to abut the wall of a different one of the pots in the assembly to retain the pots in their upright orientation.

13. The device of claim 12 wherein said arms extend in substantially opposite direction from said member.

14. The device of claim 12 further comprising members attached to the ends of said first and second arms, said members each comprising a surface adapted to abut the wall of a different one of the pots in the assembly.

15. The device of claim 14 wherein said abutting members extend in a direction substantially perpendicular to the pot separating member.

16. The device of claim 14 wherein said surfaces are shaped to accommodate the curvature of the pot wall.

17. The device of claim 12 further comprising an additional set of arms each of which extends towards and is adapted to abut the wall of a different one of the pots in the assembly.

18. A device for connecting plant pots of the type having a wall, said device comprising means for engaging the pots in side-by-side relation to form an assembly, said engaging means comprising a bifurcated pot separating member extending between the pots, said bifurcated member comprising first and second flexible branches each of which is adapted to abut the wall of a different one of the pots in the assembly to permit limited variation in the distance between the pots.
